(19) United States
(12) Patent Application Publication
(10) Pub. No.: US 2008/0187147 A1
(43) Pub. Date: Aug. 7, 2008

(54) Noise reduction systems and methods

(76) Inventors: Miranda S. Berner, Zellenople, PA (US); Ezra R. Gold, Sunnyvale, CA (US)

Correspondence Address: KIRKPATRICK & LOCKHART PRESTON GATES ELLIS LLP, 535 SMITHFIELD STREET, PITTSBURGH, PA, 15222, US

(21) Appl. No.: 11/702,408

(22) Filed: Feb. 5, 2007

(51) Int. Cl. G10K 11/16

(52) U.S. Cl. 381/71.3

(57) ABSTRACT

A noise reduction system for use with noise generating equipment. The system includes at least one sensor to generate one or more input signals, with each input signal being representative of an operating condition of the equipment. The system also includes a signal processing unit in communication each sensor to receive the input signal(s) and to generate at least one anti-noise output signal based on the input signal(s). The system further includes at least one output device in communication with the signal processing unit to generate anti-noise based on an anti-noise output signal. The anti-noise reduces noise emitted by the equipment during operation.

### TECHNICAL FIELD

The present invention relates generally to noise reduction systems, and more particularly, to noise reduction systems for use with equipment or machines that generate noise, such as, for example, air handling equipment and other sources of undesirable noise.

### BACKGROUND OF THE INVENTION

An air door, sometimes referred to as an “air curtain,” employs a controlled stream of air aimed across an opening (e.g., a building entrance) to create an air seal. This seal separates different environments, while allowing a smooth, unhindered flow of traffic and unobstructed vision through the opening. Because air doors help to contain heated or air conditioned air, they provide sizeable energy savings and personal comfort when applied in an industrial or commercial setting. Air doors may also be used to help prevent the infiltration of flying insects.

During air door operation, air is introduced into the unit through an inlet or intake and then accelerated by a fan. This fast-moving air is then introduced into a plenum designed for evenly distributing the air along the full length of a discharge nozzle or outlet. Aerofoil-shaped vanes within the nozzle create a uniform air stream with a minimum of turbulence. Typically, the nozzle is placed at the top of the opening to be sealed and is oriented such that air discharged from the nozzle creates a jet stream to the bottom of the opening (e.g., the floor).

Notwithstanding their numerous advantages, air doors may generate a substantial amount of noise during operation. Operational noise may include sound generated by the moving air streams, motor operation, fan blade rotation, and the vibration of other mechanical and electrical components of the air door. Consequently, a significant need exists for noise reduction systems that may be used with air handling equipment and other equipment to reduce or altogether eliminate noise generated during operation of the equipment.

There is still other needs for noise reduction systems that can be used to reduce to altogether eliminate noise generated by other sources of unwanted noise.

### BRIEF SUMMARY OF THE INVENTION

In one general respect, the present invention is directed to noise reduction systems for use with noise-generating equipment. According to one embodiment, the noise reduction system includes at least one sensor to generate one or more input signals, with each input signal being representative of an operating condition of the equipment. The system also includes a signal processing unit in communication each sensor to receive the input signal(s) and to generate at least one anti-noise output signal based on the input signal(s). The system further includes at least one output device in communication with the signal processing unit to generate anti-noise based on an anti-noise output signal. The anti-noise reduces noise emitted by the equipment during operation.

According to another embodiment, the noise reduction system includes a digital signal processing unit to store at least one digitized sample of noise characteristic of the equipment and to generate at least one anti-noise output signal based on the stored digitized sample(s). The system also includes at least one output device in communication with the signal processing unit to generate anti-noise based on an anti-noise output signal. The anti-noise reduces noise emitted by the equipment during operation.

In another general respect, the present invention is directed to an air handling system including an air intake; a fan, an air outlet, a signal processing unit, and at least one output device. The fan is coupled to the air intake and accelerates air received therefrom. The air outlet is coupled to the fan and distributes the accelerated air across an opening to form an air door. The signal processing unit stores at least one digitized sample of noise characteristic of operation of the air handling system and generates at least one anti-noise output signal based on the stored digitized sample(s). Each output device output device is in communication with the signal processing unit and generates anti-noise based on an anti-noise output signal. The anti-noise reduces noise emitted by the air handling system during operation.

In another general respect, the present invention is directed to methods of reducing noise generated by equipment during operation. In one embodiment, the method includes the steps of: (1) generating one or more input signals, with each input signal being representative of an operating condition of the equipment; (2) generating at least one anti-noise output signal based on the input signal(s); and (3) generating anti-noise based on an anti-noise output signal to reduce noise emitted by the equipment during operation.

In another embodiment, the method includes the steps of: (1) storing at least one digitized sample of noise characteristic of the equipment; (2) generating at least one anti-noise output signal based on the stored digitized sample(s); and (3) generating anti-noise based on an anti-noise output signal to reduce noise emitted by the equipment during operation.

### BRIEF DESCRIPTION OF THE DRAWINGS

The novel features of the various embodiments of the invention are set forth with particularity in the appended claims. The various embodiments of the invention, however, both as to organization and methods of operation, together with further objects and advantages thereof, may best be understood by reference to the following description, taken in conjunction with the accompanying drawings in which:

FIGS. 1-2 are block diagrams of noise reduction systems according to various embodiments of the present invention;

FIG. 3 illustrates a front view of an air handling system according to various embodiments of the present invention;

FIG. 4 illustrates a top view of an air handling system according to various embodiments of the present invention;

FIG. 5 illustrates a bottom view of an air handling system according to various embodiments of the present invention;

FIGS. 6-7 illustrate end views of an air handling system according to various embodiments of the present invention; and

FIGS. 8-9 are flow diagrams of methods of reducing or eliminating noise generated by equipment according to various embodiments of the present invention.

### DETAILED DESCRIPTION OF THE INVENTION

Certain exemplary embodiments will now be described to provide an overall understanding of the principles of the structure, function, manufacture, and use of the devices, systems and methods disclosed herein. One or more examples of those embodiments are illustrated in the accompanying drawings. Those of ordinary skill in the art will understand that the devices and methods specifically described herein and illustrated in the accompanying drawings are non-limiting exemplary embodiments and that the scope of the various embodiments of the present invention is defined solely by the claims. The features illustrated or described in connection with one exemplary embodiment may be combined with features of other embodiments. Such modifications and variations are intended to be included within the scope of the present invention.

Noise is sound. Sound is a longitudinal pressure wave created by a vibrating object. In general, sound is generated and transmitted in a medium, such as air. As with other types of waves, sound waves obey the principle of linear superposition, which provides that when two or more waves are present simultaneously at the same spatial location, the resultant wave is the sum of the individual waves. Consequently, when a sound wave is phase-shifted by a half-integer multiple of the wavelength and spatially located with a non-shifted wave of the same wavelength, the two sound waves are out of phase and will exhibit full destructive interference. Fully destructive interfering sound waves result in constant air pressure, and a listener or other sound detection device will detect no sound. Sound waves may also exhibit partial destructive interference if the interfering waves are out of phase by other than a half-integer multiple of the wavelength. In such cases, the sum of the individual waves will still be less than the amplitude of either wave alone. The principle of linear supposition may thus be used to reduce or eliminate noise generated by equipment during its operation.

More specifically, noise generated by equipment during its operation or from other noise generating sources may be measured. The signal indicative of the measured noise can be analog and/or digital signals. Additional operating conditions affecting operational noise may also be measured and converted into corresponding analog and/or digital signals. The term “operating condition” as used herein includes equipment noise, as well as other measurable operational parameters of the equipment such as, for example, the position and speed of a rotating shaft (e.g., fan and/or motor shaft) and vibrations of system components. The signals representative of the measured operating conditions (hereinafter input signals) may be input into a signal processing unit and processed to generate output signals representative of “anti-noise” for destructively interfering with waveforms associated with operational noise. The anti-noise output signals (hereinafter output signals) may then be transduced to physical anti-noise that destructively interferes with the operational noise, thus reducing or eliminating the operational noise. As discussed below, the process of manipulating input signals representative of measured operational conditions to generate output signals representative of anti-noise may be implemented using analog electronics and/or digital signal processing (DSP) electronics.

The term “anti-noise” as used herein includes sound, such as, for example, phase-shifted sound waves, as well as other active noise reduction outputs including, for example, playback of sampled and/or stored sound based on the position and/or speed of a fan or motor shaft. Anti-noise may also include electrical action, such as, for example, modulating motor controller output. Anti-noise may further include mechanical action, such as, for example, vibratory output of a piezoelectric or solenoid device.

It is to be understood that the principles of linear superposition, destructive interference, and anti-noise comprise active methods and techniques of noise reduction, as contrasted with passive methods and techniques, which generally refer to the use of acoustically absorbent materials, mufflers, and analogous sound damping structures and devices.

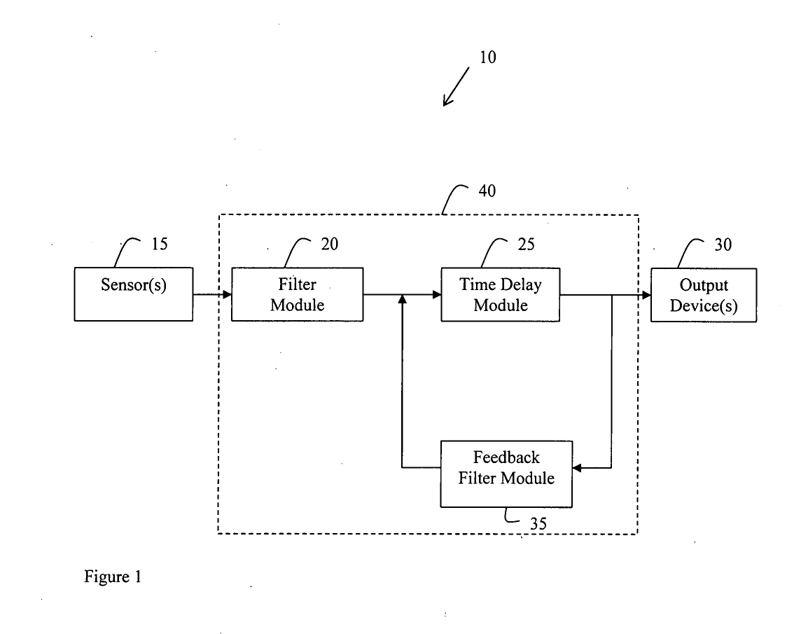

FIG. 1 illustrates an analog noise reduction system 10 for reducing (e.g., lessening or altogether eliminating) noise resulting from the operation of equipment according to various embodiments of the present invention. In certain embodiments and as described below, the system 10 may be used with air handling equipment such as, for example, an air door. However, the unique and novel aspects of the system 10 may also be effectively employed in connection with a variety of other noise generating sources, equipment, etc. In various embodiments, the system 10 includes a sensor 15, an analog signal processing unit 40, and an output device 30. The analog signal processing unit 40 may include an analog filter module 20 and an analog time delay module 25. The analog signal processing unit 40 of system 10 may further include an analog feedback filter module 35. The sensor 15 may be a measurement device structured and arranged to measure an operating condition of the equipment.

Examples of suitable sensors 15 include electroacoustic sensors to measure equipment sound (e.g., microphones), position sensors to measure the angular position of one or more rotating equipment shafts (e.g., Hall effect switches), speed sensors to measure the angular speed of one or more rotating equipment shafts (e.g., tachometers), and sensors to measure equipment vibration (e.g., accelerometers). Although only one sensor 15 is shown in FIG. 1, it will be appreciated that the system 10 may include any number and combination of sensors 15. In one embodiment, for example, the system 10 may include multiple sensors 15 of an identical type, such as, for example, multiple electroacoustic sensors for measuring sound emanating from different equipment components. Similarly, the system 10 may include sensors 15 of different types such as, for example, electroacoustic sensors, position and speed sensors, and vibration sensors for simultaneously measuring different operating conditions of the equipment. In certain embodiments, sensors 15 of identical type may be spatially positioned to define one or more arrays for measuring an operating condition across one or more regions of the air handling equipment.

Analog signal processing unit 40 may comprise an analog filter module 20, an analog time delay module 25, and an optional analog feedback filter module 35. Analog signal processing unit 40 is in communication with at least one sensor 15 to receive one or more input signals and to generate at least one anti-noise output signal based on the input signal.

Analog filter module 20, may be implemented, for example, in any suitable analog electronic circuit. For example, and without limitation, analog filter module 20 may comprise low-pass, high-pass, and/or band-pass RC, LC, RLC, and/or active op-amp implemented filter circuits.

Analog time delay module 25, may be implemented, for example, in any suitable analog electronic circuit. For example, and without limitation, analog time delay 25 may comprise an RC, LC, RLC, or active op-amp circuit.

Optional analog feedback filter module 35 may be implemented, for example, in any suitable analog circuit. For example, and without limitation, analog feedback filter module 35 may comprise an RC, LC, RLC, or active op-amp circuit.

Processing techniques may include, but are not limited to, analog delay, analog filtering based on a frequency of the input signal from the sensors, and closed loop feedback correction to cancel a portion of the filtered input signal contributed by the anti-noise.

Output device 30 is structured and arranged to receive the anti-noise signal or signals from the signal processing unit 40 and generate physical anti-noise that destructively interferes with or otherwise actively reduces the operational noise. Examples of suitable output devices 30 include electroacoustic transducers (e.g., speakers), electromechanical actuators (e.g., piezoelectric or solenoid coil type vibrators), and motor controllers (e.g., variable frequency drives). Although only one output device 30 is shown in FIG. 1, it will be appreciated that the system 10 may include any number and combination of output devices 30. In one embodiment, for example, the system 10 may include multiple output devices 30 of an identical type, such as, for example, multiple electroacoustic transducers for generating anti-noise. Similarly, the system 10 may include output devices 30 of different types such as, for example, electroacoustic transducers, electromechanical actuators, and motor controllers for simultaneously generating different anti-noise components. In certain embodiments, output devices 30 of identical type may be spatially positioned to define one or more arrays for generating anti-noise across one or more regions of the air handling equipment.

An illustrative example of one embodiment comprises an analog system for reducing operational noise in an air door system including a sensor; a signal processing unit comprising a filter module, a time delay module, a feedback filter module, and an output device. The sensor is an electroacoustic device (e.g., a microphone) placed inside or near the air door outlet. The signal from the microphone (the input signal) is filtered by the filter module to narrow the frequency spectrum of the input signal. The filtered signal is time delayed by the delay module such that it is a half-wavelength out of phase with the input signal. The resulting signal (the output signal) is representative of anti-noise. The anti-noise output signal is converted into a sound wave by an electroacoustic output device (e.g., a speaker), generating physical anti-noise that destructively interferes with the operational noise. A feedback filter module may be added to subtract the output signal from the input signal. This will expand the frequencies over which the analog noise cancellation can operate effectively by removing anti-noise measured by the sensor.

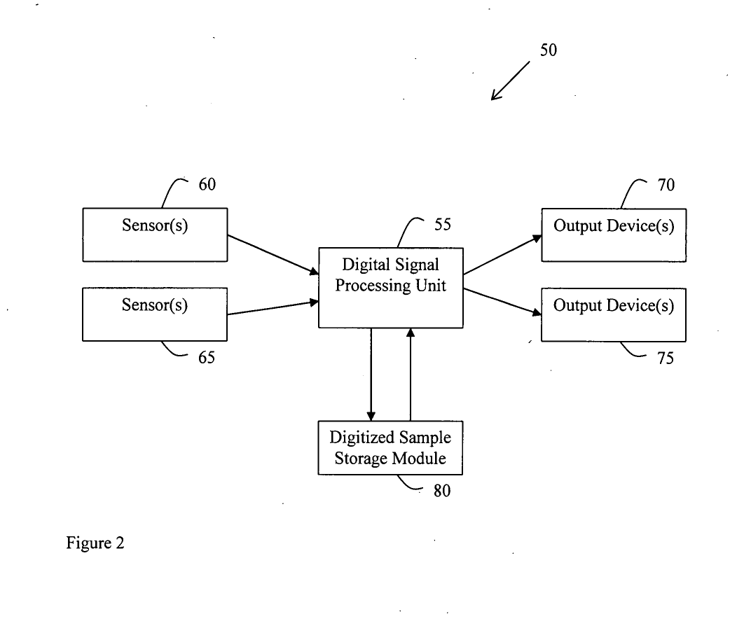

FIG. 2 illustrates a multi-input digital system 50 for reducing or eliminating operational noise including sensors 60 and 65, digital signal processing unit 55, stored noise sample 80, and output devices 70 and 75. Sensors 60 and 65 are measurement devices structured and arranged with respect to an air handling system to measure the operating conditions of the system. Sensors 60 and 65 are in communication with digital signal processing unit 55. Signal processing unit 55 is in communication with output devices 70 and 75. Stored noise sample 80 can be a separate storage module (e.g., a separate RAM or ROM module) or integrated with the digital signal processing unit 55.

Examples of suitable sensors 60 and 65 include electroacoustic sensors to measure equipment sound (e.g., microphones), position sensors to measure the angular position of one or more rotating equipment shafts (e.g., Hall effect switches), speed sensors to measure the angular speed of one or more rotating equipment shafts (e.g., tachometers), and sensors to measure equipment vibration (e.g., accelerometers). Although only two sensors 60 and 65 are shown in FIG. 2, it will be appreciated that the system 50 may include any number and combination of sensors 60 and 65. In one embodiment, for example, the system 50 may include multiple sensors 60 of an identical type, such as, for example, multiple electroacoustic sensors for measuring sound emanating from different equipment components. Similarly, the system 50 may include sensors 60 and 65 of different types such as, for example, electroacoustic sensors, position and speed sensors, and vibration sensors for simultaneously measuring different operating conditions of the equipment. In certain embodiments, sensors 60 of identical type may be spatially positioned to define one or more arrays for measuring an operating condition across one or more regions of the air handling equipment.

Digital signal processing unit 55 may include a digital delay module, a digital filtering module, an optional digital closed loop feedback correction module, and a digitized sample storage module 80. Storage module 80 may include samples of noise measured at pre-determined operating conditions (e.g., during a pre-installation equipment characterization) or samples measured during equipment operation (e.g., sampled by sensors 60 or 65).

Digital signal processing unit 55 may comprise a digital signal processor (DSP), a microprocessor, or other programmable digital electronic device. As used herein, a “processor” or “microprocessor” may be, for example and without limitation, either alone or in combination, a personal computer (PC), server-based computer, main frame, microcomputer, minicomputer, laptop and/or any other computerized device capable of configuration for processing data for standalone applications and/or over a networked medium or media. Processors and microprocessors disclosed herein may include operatively associated memory for storing certain software applications used in obtaining, processing, storing and/or communicating data. It can be appreciated that such memory can be internal, external, remote or local with respect to its operatively associated computer or computer system. Memory may also include any means for storing software or other instructions including, for example and without limitation, a hard disk, an optical disk, floppy disk, ROM (read only memory), RAM (random access memory), PROM (programmable ROM), EEPROM (extended erasable PROM), and/or other like computer-readable media.

The digital signal processing unit 55 may operate according to software code to be executed by a processor or processors of the processing unit or any other computer system using any type of suitable computer instruction type. The software code may be stored as a series of instructions or commands on a computer readable medium. The term “computer-readable medium” as used herein may include, for example, magnetic and optical memory devices such as diskettes, compact discs of both read-only and writeable varieties, optical disk drives, and hard disk drives. A computer-readable medium may also include memory storage that can be physical, virtual, permanent, temporary, semi-permanent and/or semi-temporary. A computer-readable medium may further include one or more data signals transmitted on one or more carrier waves.

Output devices 70 and 75 are structured and arranged to receive the anti-noise signal or signals from the signal processing unit 55 and generate physical anti-noise that destructively interferes with or otherwise actively reduces the operational noise. Examples of suitable output devices 70 and 75 include electroacoustic transducers (e.g., speakers), electromechanical actuators (e.g., piezoelectric or solenoid coil type vibrators), and motor controllers (e.g., variable frequency drives). Although only two output devices 70 and 75 are shown in FIG. 2, it will be appreciated that the system 50 may include any number and combination of output devices 70 and 75. In one embodiment, for example, the system 50 may include multiple output devices 70 of an identical type, such as, for example, multiple electroacoustic transducers for generating anti-noise. Similarly, the system 50 may include output devices 75 of different types such as, for example, electroacoustic transducers, electromechanical actuators, and motor controllers for simultaneously generating different anti-noise components. In certain embodiments, output devices 70 of identical type may be spatially positioned to define one or more arrays for generating anti-noise across one or more regions of the air handling equipment.

An illustrative example of one embodiment comprises a digital system for reducing operational noise in an air handling system including sensors, a digital signal processing unit with a digitized noise sample storage module, and output devices. An electroacoustic sensor (alternatively, a multiple electroacoustic sensor array) is provided to detect and measure the noise produced by the air handling system. A position sensor or speed sensor is provided to generate an input signal to serve as a timing input to the digital signal processing unit to allow signal processing to be timed to motor shaft position or motor shaft speed. The electroacoustic sensor generates a signal that is filtered and delayed as described above. Digital processing allows modifications of the filtering and delay characteristics based on inputs from the position sensor or speed sensor. For example, the filter may emphasize lower frequencies at lower motor speeds, and irregular motor or fan response can be adjusted for by varying the filter response in time with motor shaft angle. Additional noise reduction can be achieved by taking the output signal and digitally filtering and subtracting it from the input signal.

In another embodiment, a method of noise reduction includes the sampling and playback of sound. For example, some sound corresponding to noise filtered from electroacoustic sensors would be recorded into the digitized sample storage module 80. The recording and playback timing may be controlled by a position sensor, or alternatively, a speed sensor such that the samples are recorded and played back in increments of time equivalent to whole rotations of a motor shaft of air handling equipment.

Noise reduction can also be achieved by a characterization method based on measurements taken before an air unit is delivered and installed. In this embodiment, noise measurement (e.g., during a factory characterization on the particular unit or another unit of analogous design) is stored in the digitized sample storage module 80 and used in place of the microphone input signal or in combination with the microphone input signal and played back with timing determined by the position sensor, or alternatively, the speed sensor.

In various embodiments, the exact configuration and positioning of the electroacoustic sensor assembly will necessarily depend on the exact design of the air handling equipment or other noise generating source. There are several exemplary variations that are common with standard air handling equipment such as air doors. In one embodiment, a single array of electroacoustic sensors is configured and positioned in the outlet area of air door equipment. These electroacoustic sensors may be isolated from any equipment vibrations and wind noise by passive or active means in order to provide an acceptable signal for processing. Multiple electroacoustic sensors may be arrayed such that a full spectrum of noise emitted by the equipment is measured.

Additional electroacoustic or electromechanical sensors can be placed on the individual components of the equipment itself in order to detect and measure vibrations of the equipment that will become audible noise. This may be especially important when the equipment is mounted directly to a wall or other large resonant surface as the sound emitted by these surfaces may not be detected and measured by electroacoustic sensors positioned directly in an air stream.

Electroacoustic sensors (including arrays thereof) positioned externally, but in close proximity to the unit, can be used to pick up additional noise as transmitted by the unit. These electroacoustic sensors may be particularly suitable for correcting lower frequency noise using standard filter and delay methods because they will be able to correct for cabinet resonances as they interact with the room and walls. The external electroacoustic sensors may be used for noise cancellation at all frequencies using the sampling or characterization methods in combination with a position or speed sensor that will calibrate the sample playback with shaft position or speed as described hereinabove.

In certain embodiments, the exact configuration and positioning of the electroacoustic transducer assembly will necessarily depend on the exact design of the air handling equipment. There are several exemplary variations that are common with standard air handling equipment such as air doors. In one embodiment, a standard electroacoustic transducer (e.g., a speaker) is placed in the outlet of the unit. This can be expanded to an array of several electroacoustic transducers within the unit for better performance on units which have large aspect ratio outlets. The array of electroacoustic transducers can be set up with each transducer receiving a different anti-noise signal. The different anti-noise signals can be generated by any of the systems described above.

Output transducers can also be non-traditional. For example, a piezoelectric or conventional magnet and coil (solenoid-type actuators) may be directly mounted to various equipment components such that it will vibrate the components to reduce the inherent vibrations.

In additional embodiments, noise reduction can be achieved by controlling a motor controller with the output signals from the signal processing unit. Variable frequency drive (VFD), alternating current (AC), and pulse width modulated (PWM) motors may be controlled by the output signal (e.g., modulated at audio frequencies) such that the coil harmonics associated with an operating motor are reduced or eliminated. This embodiment has the added benefit that harmonic resonances of the motor and fan can be counteracted by the motor modulation.

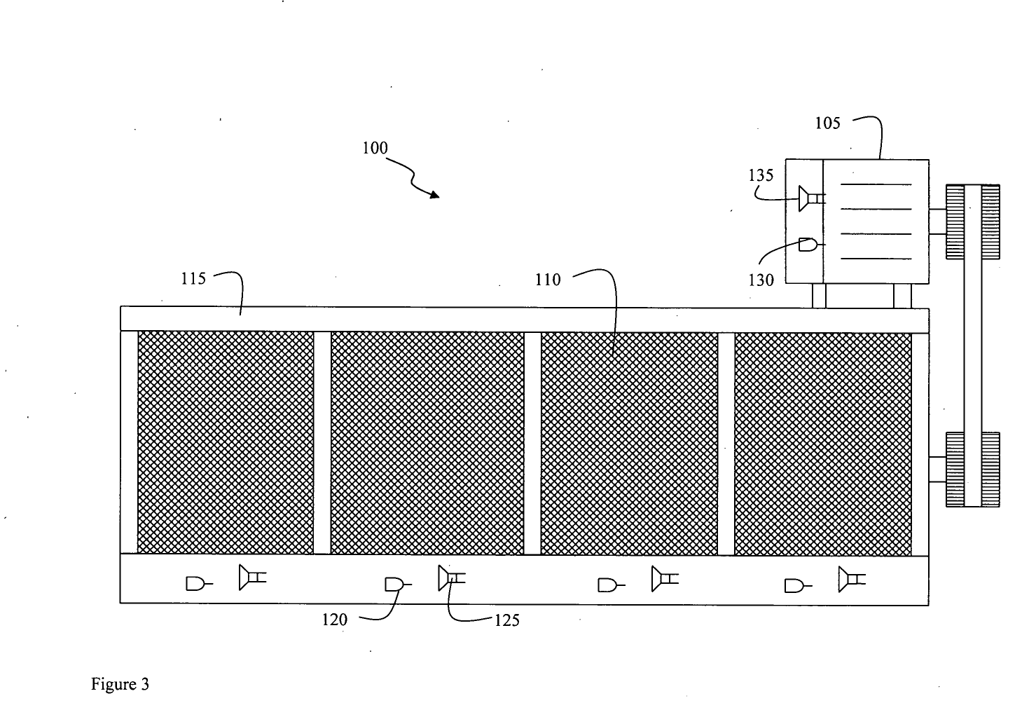

FIG. 3 is a front view of an air door system 100 according to non-limiting embodiments of the present invention. The air door system 100 includes a drive motor 105, an air intake 110, and a cabinet 115. A plurality of sensors 120 are positioned in an array located on the cabinet 115, adjacent to air intakes 110. A plurality of output devices 125 are positioned in an array located on cabinet 115, adjacent to air intakes 110. Sensor 130 and output device 135 are positioned and mounted directly to the side of motor 105.

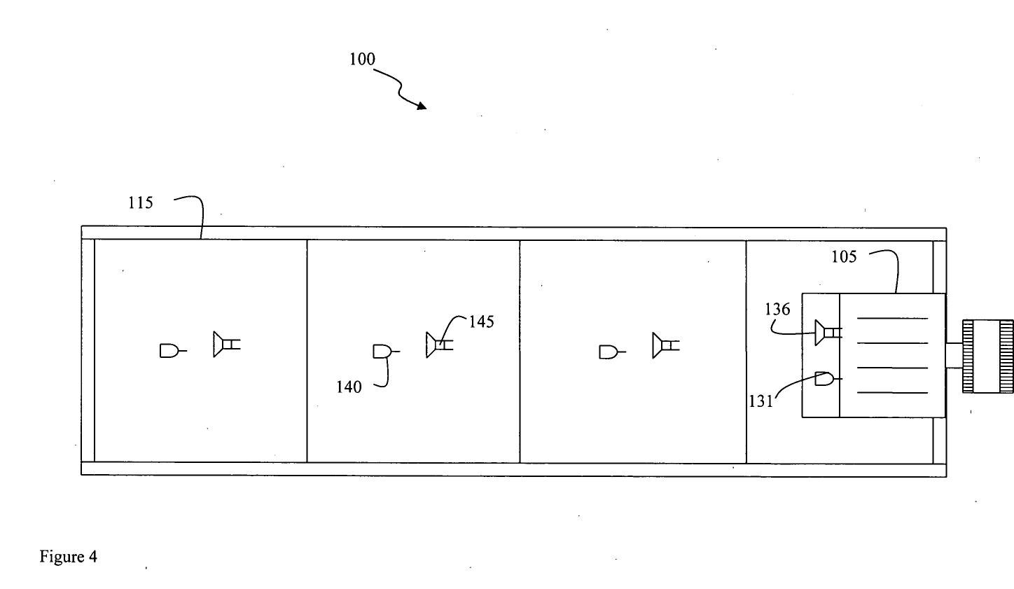

FIG. 4 is a top view of an air door system 100 according to non-limiting embodiments of the present invention. A plurality of sensors 140 and a plurality of output devices 145 are positioned in arrays on the top external surface of cabinet 115. Sensor 131 and output device 136 are positioned and mounted directly to the top of motor 105.

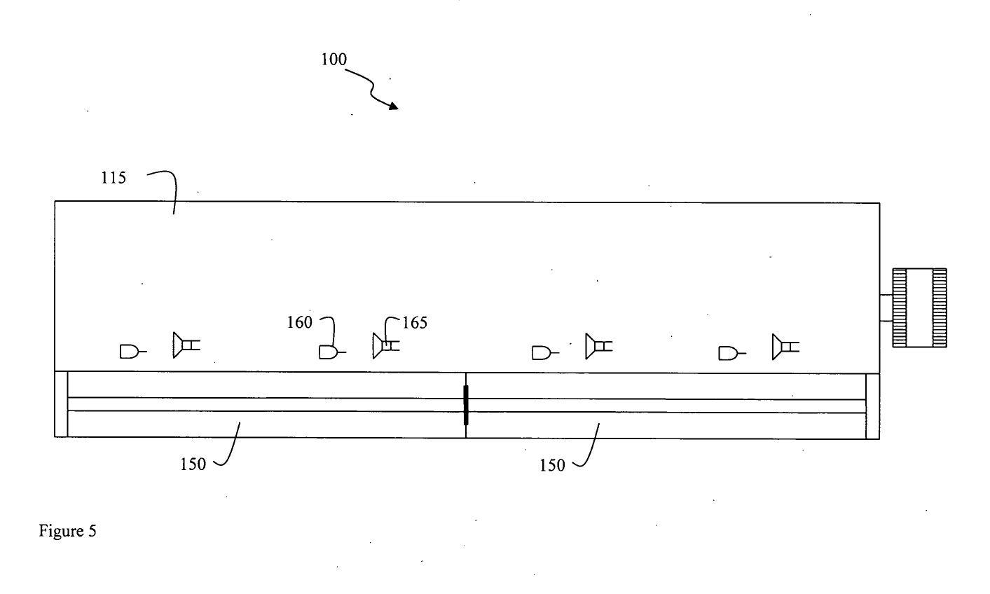

FIG. 5 is a bottom view of an air door system 1100 according to non-limiting embodiments of the present invention. A plurality of sensors 160 and a plurality of output devices 165 are positioned in arrays on the bottom external surface of cabinet 115 adjacent to air outlet 150.

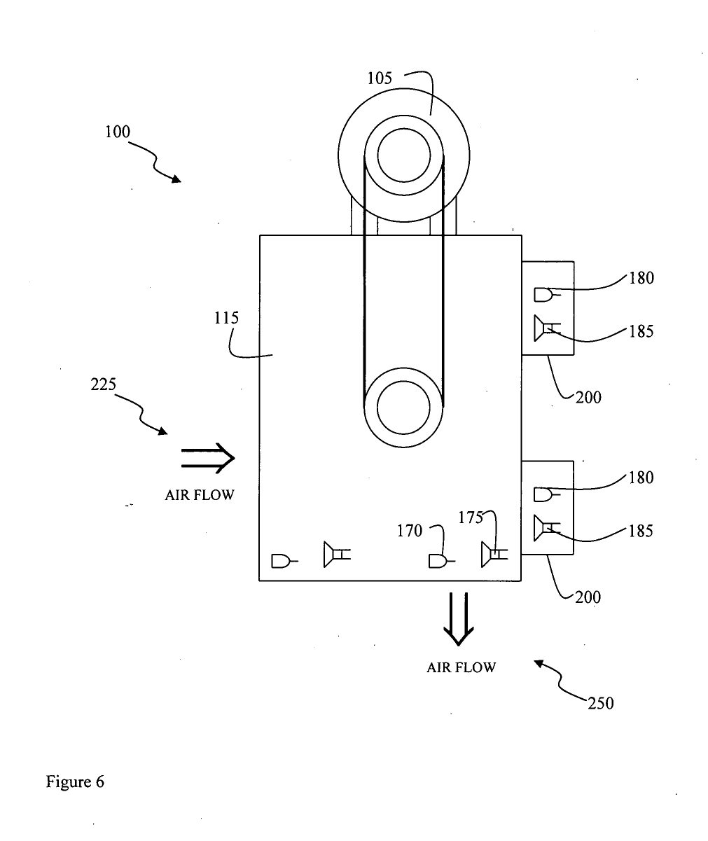

FIG. 6 is an end view of an air door system 100 according to non-limiting embodiments of the present invention. Sensor 170 and output device 175 are positioned on the side external surface of cabinet 115. Intake airflow 225 enters the air door on the front side and discharge airflow 250 exits the air door from the bottom side. Sensor 180 and output device 185 are positioned and mounted directly to mounting bracket 200. Mounting bracket 200 is used to mount air door 100 to a wall or other surface.

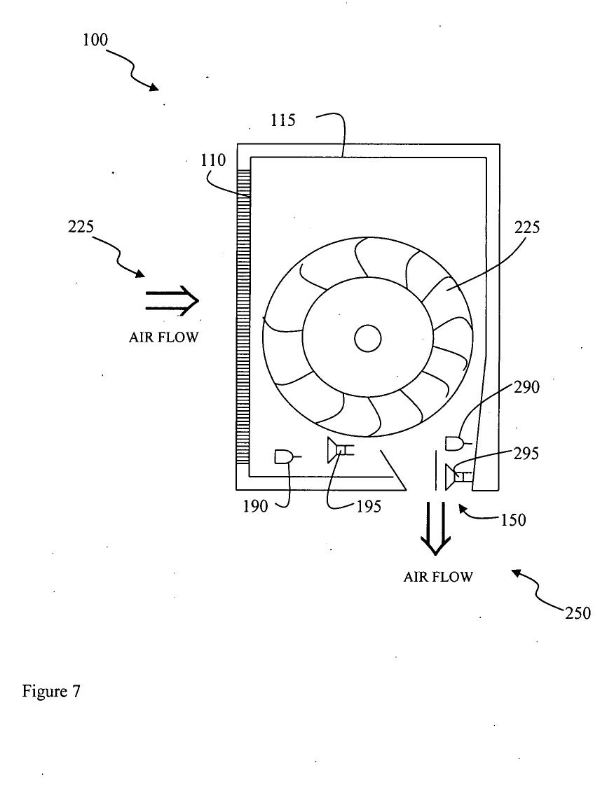

FIG. 7 is a cross-sectional end view of an air door system 100 according to non-limiting embodiments of the present invention. Sensor 190 and output device 195 are positioned and mounted on air door unit 100 internally, and adjacent to air intake 110 and fan/blower 225. Sensor 290 and output device 295 are positioned and mounted on air door unit 100 internally, and adjacent to air outlet 150 and fan/blower 225.

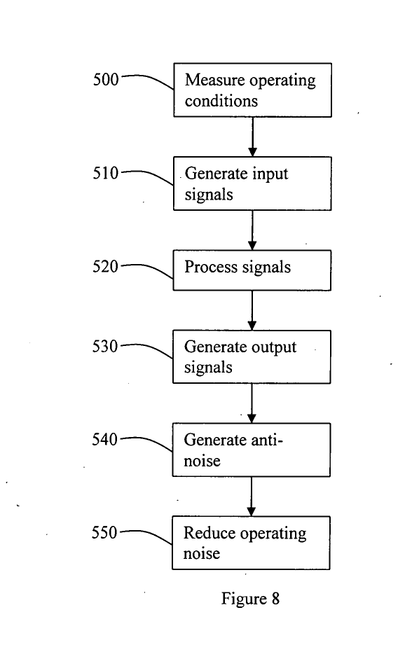

FIG. 8 is a flow diagram of a method of reducing or eliminating noise generated by air handling equipment according to various embodiments of the present invention. The operating conditions of the air handling equipment (which may include equipment noise, as well as other measurable operational parameters of the equipment such as, for example, the position and speed of a rotating shaft (e.g., fan and/or motor shaft), and component vibrations) are measured at step 500 by sensors (which may include electroacoustic sensors to measure equipment sound (e.g., microphones), position sensors to measure the angular position of one or more rotating equipment shafts (e.g., Hall effect switches), speed sensors to measure the angular speed of one or more rotating equipment shafts (e.g., tachometers), and sensors to measure equipment vibration (e.g., accelerometers)).

At step 510, the operating condition measurements from step 500 are used to generate at least one input signal. The at least one input signal is generated by the sensors and is communicated to a signal processing unit.

At step 520, the signal processing unit receives the at least one input signal from the sensors and processes the at least one signal to generate at least one output signal representative of anti-noise at step 530. The at least one output signal may be based on the one or more input signals. The one or more output signals are then communicated to one or more output devices

At step 540, the at least one output device receives the one or more output signals and generates anti-noise based on an output signal. The anti-noise reduces noise emitted by the equipment during operation at step 550.

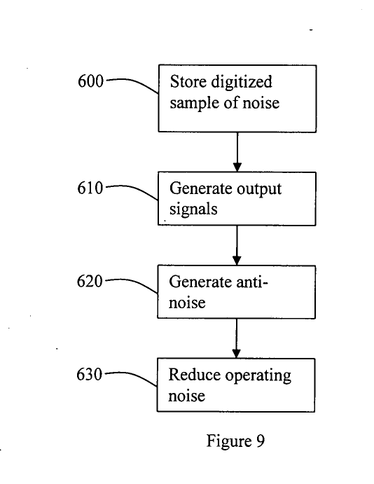

FIG. 9 is a flow diagram of a method of reducing or eliminating noise generated by air handling equipment according to various embodiments of the present invention. At step 600, at least one digitized sample of noise characteristic of noise generating equipment is measured and stored. For example the sample(s) may be measured with an electroacoustic sensor and stored in a digital signal processing unit.

At step 610, the sample(s) from step 600 are used to generate at least one output signal representative of anti-noise. The at least one output signal may be based solely on the stored digitized sample(s) or may also be based on the stored digitized sample(s) and one or more input signals (not shown). The one or more output signals are then communicated to one or more output devices

At step 620, the at least one output device receives the one or more output signals and generates anti-noise based on an output signal. The anti-noise reduces noise emitted by the equipment during operation at step 630.

All of the components described hereinabove are combined in various combinations to actively reduce the noise level in the area of the air handling equipment regardless of the operational state of the equipment. Furthermore, the above described active noise reduction systems, devices, and methods can be combined with passive noise reduction methods that attenuate the amplitude of the noise sound waves (e.g., passive damping material such as acoustically absorbent panels, mufflers, or analogous sound damping devices). Such hybrid systems, devices, and methods provide partial passive and partial active noise control. For example, and without limitation, low frequency noise can be suppressed actively with various embodiments of the present invention and high frequency noise can be controlled by passive damping means.

It is to be understood that the figures and descriptions of the present invention have been simplified to illustrate elements that are relevant for a clear understanding of the present invention, while eliminating, for purposes of clarity, other elements, such as, for example, details regarding specific hardware components such as signal processing units, sensors, and output devices. Those of ordinary skill in the art will recognize that the specific air handling equipment of interest will dictate the type, configuration, and positioning of the measurement, processor, and output devices. However, because the technical details and functionality of such elements are well known in the art and because they do not facilitate a better understanding of the present invention, a detailed discussion of such elements is not provided herein.

The present invention has been generally described in the context of noise reduction of air handling equipment, particularly air curtains or air doors. However, one skilled in the art will appreciate that the present invention is generally applicable to any type of equipment that generates unwanted operational noise, for example, in a cyclic, periodic, or constant mode. Additional applications may include, but are not limited to, active noise reduction of operating pumps, compressors, fans, blowers, turbines, generators, motors, hydraulic/pneumatic cylinders, and electromechanical equipment generally. In such embodiments, the sensors, signal processing units, and output devices are structured and arranged in accordance with the sound characteristics of the particular noise-generating equipment of interest.

Embodiments of the present invention are directed to systems for reducing or eliminating operational noise of equipment by measuring the noise and/or other equipment operating conditions, processing signals representative of the measurements, and controlling one or more output devices based on the processed signals to generate anti-noise that destructively interferes with and actively attenuates the operational noise. Although embodiments of the present invention are described herein with respect to their use with air handling equipment in particular, it will be appreciated that such embodiments are provided by way of example only and that the present invention may generally be used with any type of equipment that generates operational noise and other sources of noise. Thus, the protection afforded to the various embodiments of the subject invention as defined by the appended claims should not be limited to use in connection with a specific form of equipment (e.g., air handling equipment, air doors, etc.). It will further be appreciated that the embodiments described herein are not limited to the particular construction and arrangement of the components set forth in the following description and illustrated in the accompanying drawings. The described embodiments are capable of other forms and may be carried out in various ways Also, it will be understood that the phraseology and terminology used herein is for purpose of description and should not be regarded as limiting. Therefore, this application is intended to cover all such modifications, alterations and adaptations without departing from the scope and spirit of the disclosed invention as defined by the appended claims.

What is claimed is:

1. A noise reduction system for use with noise generating equipment, comprising:
at least one sensor to generate one or more input signals, each input signal representative of an operating condition of the equipment;
a signal processing unit in communication with the at least one sensor to receive the one or more input signals and to generate at least one anti-noise output signal based thereon; and
at least one output device in communication with the signal processing unit to generate anti-noise based on an anti-noise output signal, the anti-noise to reduce noise emitted by the equipment during operation.

2. The system of claim 1, wherein the equipment comprises an air door.

3. The system of claim 1, wherein each at least one sensor is selected from the group consisting of: an electroacoustic sensor, a position sensor, a speed sensor, and a vibration sensor.

4. The system of claim 1, wherein the operating condition represented by the input signal of each at least one sensor is one of sound, position, speed, and vibration.

5. The system of claim 1, further comprising an array of sensors.

6. The system of claim 1, wherein each at least one output device is selected from the group consisting of: an electroacoustic transducer, an electromechanical actuator, and a motor controller.

7. The system of claim 1, further comprising an array of output devices.

8. The system of claim 1, wherein the signal processing unit comprises:
at least one filter module to filter an input signal received from the at least one sensor based on a frequency of the input signal; and
at least one time delay module in communication with the at least one filter module, each at least one time delay module to receive a filtered input signal and to generate an anti-noise output signal by introducing a phase shift to the filtered input signal.

9. The system of claim 8, wherein the signal processing unit further comprises at least one feedback filter module in communication with the at least one filter module and the at least one time delay module, the at least one feedback filter module to cancel a portion of the filtered input signal contributed by the anti-noise.

10. The system of claim 9, further comprising a microprocessor, wherein the microprocessor includes the at least one filter module, the at least one time delay module, and the at least one feedback filter module.

11. The system of claim 10, the microprocessor to modify a frequency response of the at least one filter module or the at least one feedback filter module based on an input signal received from the at least one sensor.

12. A noise reduction system for use with noise generating equipment, comprising:
a signal processing unit to store at least one digitized sample of noise characteristic of the equipment and to generate at least one anti-noise output signal based on the stored at least one digitized sample; and
at least one output device in communication with the signal processing unit to generate anti-noise based on an anti-noise output signal, the anti-noise to reduce noise emitted by the equipment during operation.

13. The system of claim 12, further comprising at least one sensor to generate one or more first input signals representative of the characteristic noise.

14. The system of claim 13, wherein the signal processing unit is in communication with the at least one sensor, the signal processing unit to acquire the at least one digitized sample from the one or more first input signals.

15. The system of claim 14, the signal processing unit to control the generation of the at least one anti-noise output signal or the acquisition of the at least one digitized sample based on one or more second input signal received by the signal processing unit.

16. The system of claim 15, wherein each of the one or more second input signals is representative of a speed or a position of a component of the equipment.

17. The system of claim 16, further comprising at least one of a position sensor and a speed sensor to generate the one or more second input signals.

18. An air handling system, comprising:
an air intake;
a fan coupled to the air intake to accelerate air received therefrom;
an air outlet coupled to the fan to distribute the accelerated air across an opening to form an air door;
a signal processing unit to store at least one digitized sample of noise characteristic of operation of the air handling system and to generate at least one anti-noise output signal based on the stored at least one digitized sample; and
at least one output device in communication with the signal processing unit to generate anti-noise based on an anti-noise output signal, the anti-noise to reduce noise emitted by the air handling system during operation.

19. A method of reducing noise generated by equipment during operation, comprising:
generating one or more input signals, each input signal representative of an operating condition of the equipment;
generating at least one anti-noise output signal based on the one or more input signals; and
generating anti-noise based on an anti-noise output signal, the anti-noise to reduce noise emitted by the equipment during operation

20. A method of reducing noise generated by equipment during operation, comprising:
storing at least one digitized sample of noise characteristic of the equipment;
generating at least one anti-noise output signal based on the stored at least one digitized sample; and
generating anti-noise based on an anti-noise output signal, the anti-noise to reduce noise emitted by the equipment during operation.
